(19) United States
(12) Patent Application Publication
(10) Pub. No.: US 2026/0357773 A1
(43) Pub. Date: Nov. 12, 2026

(54) PRECLEANER COUPLER FOR PRECLEANER SYSTEM

(71) Applicant: Caterpillar Inc., Peoria, IL (US)

(72) Inventors: Timothy S. FINN, Morton, IL (US); David J. COLANTONI, Metamora, IL (US)

(73) Assignee: Caterpillar Inc., Peoria, IL (US)

(21) Appl. No.: 19/204,031

(22) Filed: May 9, 2025

(51) Int. Cl. F02M 35/02; F02M 35/022

(52) U.S. Cl. CPC F02M 35/0202; F02M 35/0205; F02M 35/0223

(57) ABSTRACT

A precleaner coupler for a precleaning system may include a first grooved track having a first groove opening extending along a length of the first grooved track. A precleaner coupler may include a second grooved track parallel to the first grooved track, the second grooved track having a second groove opening extending along a length of the second grooved track. The first groove opening and the second groove opening may face one another. A precleaner coupler may include at least one precleaner guard element extending from the first grooved track to the second grooved track.

### TECHNICAL FIELD

The present disclosure relates generally to an air cleaner, and more particularly, to a precleaner coupler for a precleaner system.

### BACKGROUND

Precleaner systems are used in mobile industrial machine air intake systems, such as the air intake system of a front loader, to separate dust from air in order to prolong the service life of filter elements and engine components. Some styles of precleaner systems include removable covers that allow for cleaning and servicing of the internal components. These covers include an embbeded seal to keep unwanted particulates from entering into the system. The covers also include latches that can have a double hinge (over-center) design and are made of plastic. The latches may provide the force necessary to compress the seal within the cover to the body of a precleaner. As the latches wear or fail over time, the clamping force that the latches exert on the seal may be reduced, and/or the cover may break off partially or entirely from the precleaner. Precleaners also need rainshields in some cases to keep water from entering the intake. These are held in place in some cases by simple clips built into the shield itself.

Chinese Utility Model No. CN221169791U, published on Jun. 18, 2024, (“the '791 Utility Model”) describes a waterproof device “suitable for being arranged at the opposite ends of two adjacent air filters of an engine, each end is provided with an air inlet of the corresponding air filter, and the waterproof device comprises a waterproof shielding piece.” ('791 Utility Model, Abstract.) The shielding member simultaneously covers air inlets at two ends of the two air filters, thereby assisting in preventing rainwater from being sucked into the air filter from the space between the two air inlets. The shield may include a plurality of through holes for fixing the shield member to corresponding portions of each air filter using fasteners. The waterproof shield may also include an elastic member that may wrap around the air filters and connect the ends of the shield member. The fasteners and elastic member used to fix the shield to the air filters may be subject to wear over time and may be cumbersome to undue during servicing.

The precleaner coupler for a precleaner system of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a precleaner coupler for a precleaning system. The precleaner coupler includes a first grooved track having a first groove opening extending along a length of the first grooved track and a second grooved track parallel to the first grooved track. The second grooved track includes a second groove opening extending along a length of the second grooved track. The first groove opening and the second groove opening face one another and at least one precleaner guard element extends from the first grooved track to the second grooved track.

In another aspect, the disclosure relates to a precleaner system for precleaning intake air for an air intake system. The precleaner system includes a cyclonic precleaner having a precleaner outer wall with a plurality of precleaner inlets extending through the precleaner outer wall, and each precleaner inlet is in fluid communication with the intake air. The cyclonic precleaner further includes a housing and a plenum formed by the housing and the precleaner outer wall from each of the plurality of precleaners. The plenum is in fluid communication with the plurality of precleaner inlets. The cyclonic precleaner also includes a system inlet in the shape of a hollow cylinder extending away from the housing and in fluid communication with the plenum. The cylclonic precleaner further includes a precleaner coupler with a first grooved track having a first groove opening extending along a length of the first grooved track and a second grooved track having a second groove opening extending along a length of the second grooved track. The first groove opening and the second groove opening face one another and are sized to clamp the precleaner outer wall to the housing.

In a further aspect, the disclosure relates to a method of assembling a cyclonic precleaner. The method includes placing an outer wall having a plurality of precleaner inlets extending through the precleaner outer wall onto a housing, such that the outer wall and the housing form a plenum. The method further includes sliding a precleaner coupler over at least a portion of the outer wall and the housing to clamp the outer wall to the housing. The precleaner coupler of the method includes a first grooved track having a first groove opening extending along a length of the first grooved track, and a second grooved track having a second groove opening extending along a length of the second grooved track. The first groove opening and the second groove opening face one another and are sized to clamp the precleaner outer wall to the housing.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a mobile machine with a precleaner system, according to aspects of the disclosure.

FIG. 2 is an exploded view of the precleaner of the precleaner system of FIG. 1.

FIG. 3 is a front perspective view of a precleaner coupler of the precleaner system of FIG. 1

FIG. 4 is a rear perspective view of the precleaner coupler of the precleaner system of FIG. 1

FIG. 5 is a section view of the precleaner of the precleaner system of FIG. 1.

FIG. 6 is a front perspective view of an alternative precleaner coupler, according to aspects of this disclosure.

FIG. 7 is a front perspective view of an alternative precleaner coupler, according to aspects of this disclosure.

FIG. 8 is a front perspective view of an alternative precleaner coupler, according to aspects of this disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

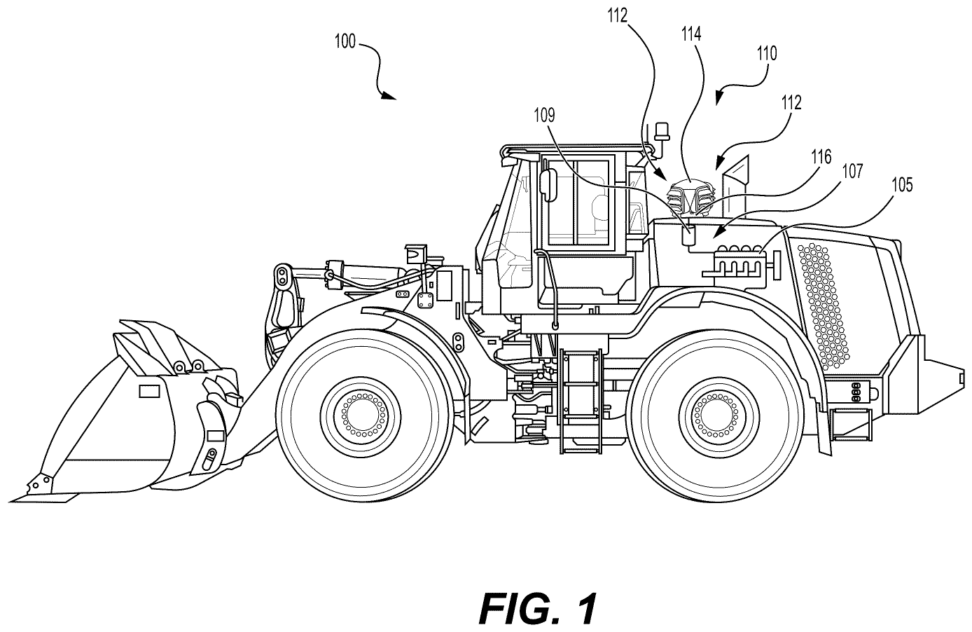

As shown in FIG. 1, a mobile machine 100 in the form of a wheel loader machine, that includes an internal combustion engine 105, and an engine air intake system 107. Engine air intake system is configured to receiving environmental air (i.e., intake air) and remove particulate matter such as dust, dirt, particulates, water, and other like debris from the intake air, and direct cleaned intake air to the engine 105 for use in the combustion process. While a wheel loader machine is depicted in FIG. 1 the aspects of this disclosure may be applied to any industrial machine having an engine, such as a track-type tractor, backhoe loader, motor grader, articulated truck, pavers, cold planers, haulers, excavators, gensets, etc.

The engine air intake system 107 can be a two-stage system. The first stage includes a precleaner system 110, upstream of the second stage that includes an air filter system 109 having one or more air filters. The precleaner system 110 may include one or more cyclonic precleans 112 within a housing 114. The precleaner system 110 may be fluidly connected to the engine 105 by a hollow cylindrical outlet 116 extending axially downward and away from the housing 114 towards the engine 105 of the mobile machine 100.

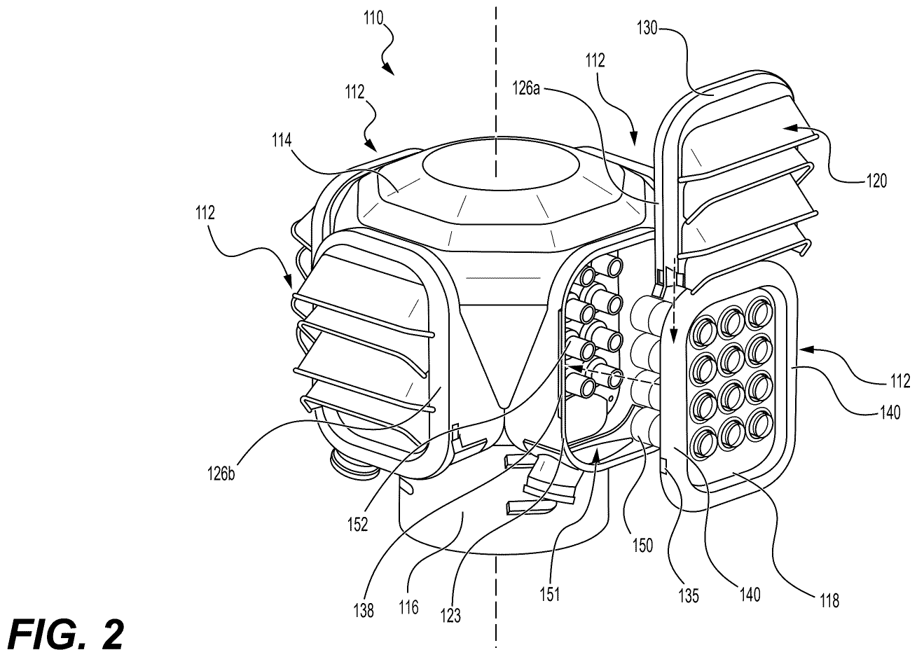

FIG. 2 depicts an exploded view of the precleaner system 110. As shown in FIG. 2, the precleaner system 110 includes four precleaners 112 formed in part by the housing 114 which extends between each precleaner 112. The precleaners 112 may be equally angularly spaced and extend radially about a central vertical axis Y of the housing 114. Each precleaner 112 may be in fluid communication with the cylindrical outlet 116 through the housing 114. As best shown FIG. 2, each precleaner 112 may further include a precleaner outer wall or cover 118 clamped to an outer opening 123 of the housing 114 by a precleaner coupler 120. The outer opening 123, the precleaner outer walls 118, and the precleaner couplers 120 may be generally rectangular, and the longitudinal sides of the outer opening 123, precleaner outer walls 118, and the precleaner couplers 120 may be parallel to the central axis Y of the housing 114.

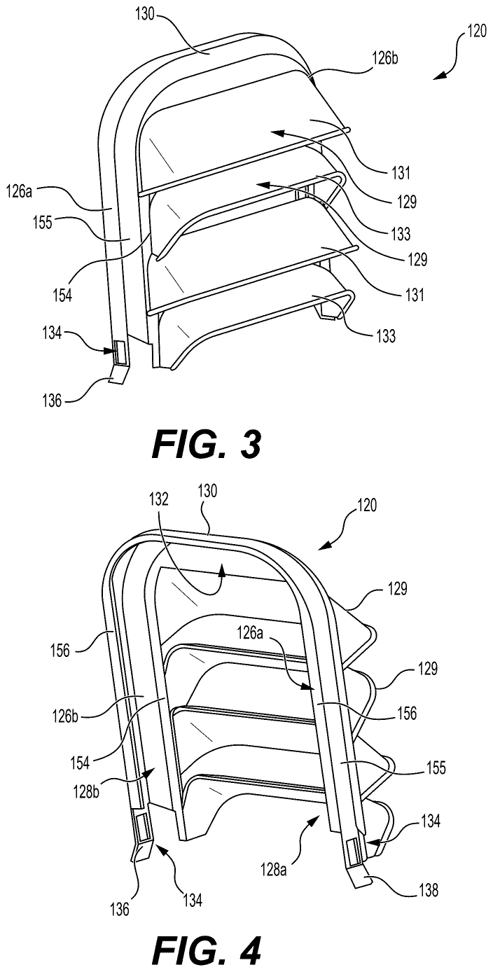

FIG. 3 depicts a front perspective view of a precleaner coupler 120 of the precleaner system 110, and FIG. 4 depicts a rear perspective view of the precleaner coupler 120 of the precleaner system 110. Referring now to FIGS. 3 and 4, the precleaner coupler 120 includes a pair of longitudinal grooved tracks 126a, 126b that form the longitudinal sides of the precleaner coupler 120. The longitudinal grooved tracks 126a, 126b of the precleaner coupler 120 may form a generally C or U shape that face each other, and include a front wall 154 that is generally parallel to a backwall 156. Intermediate side walls 155 may connect the front wall 154 to the backwall 156.

The longitudinal grooved tracks 126a, 126b include a longitudinal groove opening 128a, 128b that extends along the length of the respective longitudinal grooved tracks 126a, 126b. The longitudinal groove opening 128a of the longitudinal grooved track 126a may generally face the longitudinal groove opening 128b of the longitudinal groove track 126b, such that the intermediate side walls 155 of longitudinal groove openings 128a, 128b generally face each other.

A distal or bottom end of the longitudinal grooved tracks 126a, 126b may each include a catch 134 in side walls 155 for engagement with a locking ramp or angled protrusion 135 (FIG. 2) on the bottom edges of precleaner outer walls 118. The catch 134 may be formed of an opening through side wall 155, such as a rectangular opening for snap-fit receiving of the locking ramp 135. The longitudinal grooved tracks 126a, 126b may further include releasing tabs 136 for releasing the locking ramps 135 of the precleaner outer walls 118 from the catches 134 for removing the precleaner coupler 120. The tabs 136 may be located at the distal-most end of side walls 155 and be sloped such that each tab 136 extends away from the surface of a corresponding adjacent precleaner outer wall 118.

The precleaner coupler 120 may further include a widthwise groove 130 extending between, and normal to, the longitudinal grooved tracks 126a, 126b. The widthwise groove 130 may be shorter than the length of the longitudinal grooved tracks 126a, 126b and form a widthwise side or top of the precleaner coupler 120. The widthwise groove 130 may include a widthwise groove opening 132 that opens towards the longitudinal groove openings 128a, 128b.

The precleaner coupler 120 may also include one or more guard portions 129 that extend between the front wall 154 of the longitudinal grooved tracks 126a, 126b. As shown in FIGS. 1-7, the guard portions may be louvers or baffles. As discussed further below, the guard portions 129 may be other structures that extend between the longitudinal grooved tracks 126a, 126b, or may be omitted.

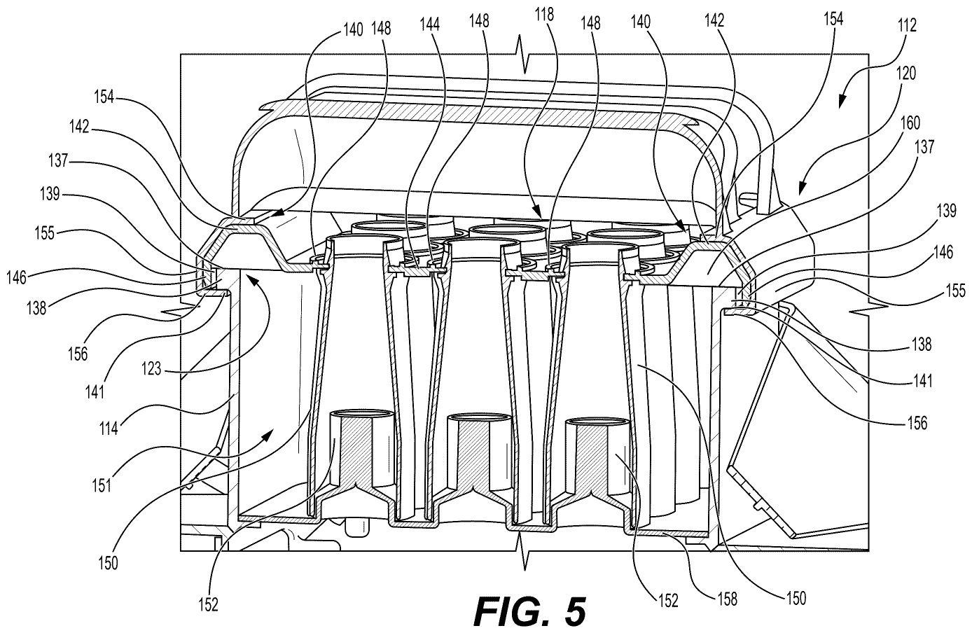

FIG. 5 is a section view of a precleaner 112 of the precleaner system 110, with the precleaner outer walls 118 secured to the housing 114 by the precleaner coupler 120. As shown in FIG. 5, rectangular (e.g., square) guide rails 138 may run along the outer longitudinal edges of the outer opening 123 formed by the housing 114. The rails 138 may include a forward rail face 137, a bottom rail face 141 parallel to the forward rail face 137, and a side rail face 139 connecting the forward rail face 137 to the bottom rail face 141.

The precleaner outer walls 118 may further include an engagement surface 140 along at least the longitudinal edges of a central portion 144. The engagement surface 140 may include a front facing portion 142 spaced forward from, and arranged parallel to, the central portion 144 of the precleaner outer wall 118. The engagement surface 140 may also include side portions 146 that are generally perpendicular to the front facing portion 142, and may face or frictionally engage the side rail face 139 of the rails 138 of the housing 114. The central portion 144 may include one or more precleaner inlets 148 that extend through the precleaner outer wall 118.

Between the engagement surface 140 of the precleaner outer wall 118 and the outer opening 123 of the housing 114 may be a seal 160. The seal 160 may fully encompass the outer opening 123 of the housing 114, and may separate the forward rail face 137 of the rails 138 from the front facing portion 142 of the engagement surface 140 of the precleaner outer wall 118. The seal 160 may be water and/or airtight, and may be made from any suitable material, for example, silicon. In some examples, the seal 160 may be a gasket. In other examples the seal 160 may be a filler and sealant material, such as caulk.

As shown in FIG. 5, with the precleaner coupler 120 engaged, the longitudinal grooved tracks 126a, 126b may engage the rails 138 of the housing 114 and the engagement surface 140 of the precleaner outer walls 118 such that the precleaner coupler 120 simultaneously engages the housing 114 and precleaner outer walls 118. More specifically, the front wall 154 of the longitudinal grooved tracks 126a, 126b of the precleaner coupler 120 may contact the front facing portion 142 of the engagement surface 140 of the precleaner outer wall 118, and the backwall 156 of the longitudinal grooved tracks 126a, 126b of the precleaner coupler 120 may contact the bottom rail face 141 of the rails 138 of the housing 114. The shape and size of the longitudinal grooved tracks 126a, 126b may be such that the precleaner coupler 120 compresses the precleaner outer wall 118 onto the housing 114, compresses the seal 160 and, secures and seals the precleaner outer wall 118 in position.

Still referring to FIG. 5, a plenum 151 may be formed by the precleaner outer wall 118 and the housing 114 of a precleaner 112. Within the plenum 151 may be a number of inlet tubes 150 aligned with and/or attached to respective precleaner inlets 148 of the precleaner outer walls 118. The inlet tubes 150 may extend perpendicular to the precleaner outer walls 118, and may be axially aligned with respective inlet tubes 152 extending perpendicularly from an inner wall 158 of the housing 114 opposite the precleaner outer walls 118.

### Industrial Applicability

The disclosed aspects of the precleaner coupler of the precleaner system of the present disclosure may be used to secure a precleaner outer wall to a housing of a precleaner, in order to provide a precleaner system to filter intake air used by a mobile machine, such as a front loader mobile machine.

Referring back to FIG. 2, the precleaner 112 may be assembled by placing the precleaner outer walls 118 on the housing 114 such that the engagement surface 140 of the precleaner outer walls 118 cover the outer opening 123 of the housing 114, and especially the rails 138 of the housing 114. In doing so, the inlet tubes 150 attached to the precleaner outer walls 118 may align with and surround respective inlet tubes 152 of the housing 114. To secure the precleaner outer walls 118 to the housing 114, The precleaner coupler 120 may slide down over the precleaner outer walls 118 and the housing 114 such that the longitudinal grooved tracks 126a, 126b of the precleaner coupler 120 clamp the precleaner outer walls 118 to the housing 114. Specifically, the precleaner coupler 120 may exert a forward clamp force on the housing 114 and a rearward force on the precleaner outer walls 118, compressing the seal (FIG. 5) between the two. As the precleaner coupler 120 slides down the precleaner outer wall 118, the angled protrusions 135 on the precleaner outer wall 118 may slide into and engaged the respective catch 134 on the precleaner coupler 120, thereby locking the precleaner coupler 120 into place. To unlock the precleaner coupler 120 from the precleaner outer wall 118, an outwards force may be applied to the tabs 136 on the longitudinal grooved tracks 126a, 126b, which may cause the angled protrusions 135 to disengage with the respective catches 134, and allow for the precleaner coupler 120 to slide up and away from the precleaner outer walls 118. In some examples, the friction between the precleaner outer wall 118 and precleaner coupler 120 may keep the precleaner coupler 120 locked to the precleaner outer walls 118.

The longitudinal grooved tracks 126a, 126b may provide a large surface area by which compression forces can be applied to the precleaner outer walls 118 and precleaner coupler 120. The unitary structure of the longitudinal grooved tracks 126a, 126b may be less susceptible to wear or failure than other attachment means, such as latches, and may provide an effective clamping force over a greater area for a longer period of time. The integration of guard portions 129 onto the precleaner coupler 120 may help to prevent unwanted rain and/or particulates from entering into the engine 105 of the precleaner system 110. As the precleaner couplers 120 slide on and off, the precleaner couplers 120 may be easily removed for servicing and/or swapped so that different guard portions 129 may be used in different work environments.

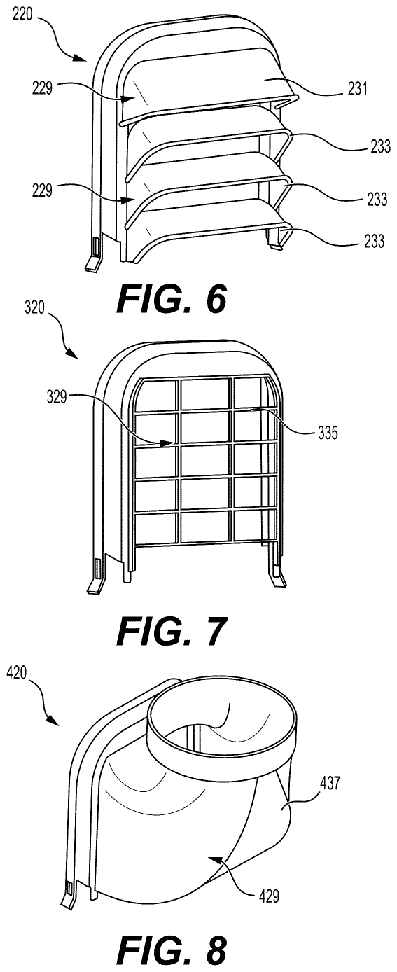

As described above in reference to FIGS. 1-5, the one or more guard portions 129 of the precleaner coupler 120 may be downwardly projecting louvers situated at different angles or having different shapes. For example, as shown in FIG. 3, guard portion 129 may include two louvers 131 being at the same angle and shape, and alternating with two identical louvers 133 that have a different angle and shape than louvers 131. In this arrangement of guard portions 129, the outer wall is fully covered when viewed from an angle (e.g., 30 degrees) above the precleaner coupler 120, corresponding to a maximum horizontal rain angle. FIGS. 6-8 are front perspective views of alternative precleaner couplers 120 with different guard portions 129. As shown in FIG. 6 the precleaner coupler 220 may have guard portions 229 including a plurality of identical louvers 233, such as three identical louvers 233 at the same angle and/or having the same shape, and a top louver 231 that is substantially at the same angle as the louvers 233, but longer in shape. As shown in precleaner coupler 320 of FIG. 7, the one or more guard portions 329 of the precleaner coupler 120 may be screening bars 335 extending in a grid pattern that provide a support and protection system. A screen (not shown) may be included on precleaner coupler 320 and supported by screening bars 335, such that the screen covers the outer opening 123 of the housing 114 (FIGS. 1-2, 5-6). As shown in FIG. 8, a precleaner coupling 420 may include a guard portion 429 in the form of a duct 437that provides further control over the direction of airflow into the precleaner system 110, for example when the initial air inlet to the system 110 needs to be located at a different location than the precleaner housing 114. In other examples, the one or more guard portions 129 may be different from those described above. In some examples, the guard portions 129 may be omitted entirely and the precleaner coupling 120 may only serve the coupling function.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A precleaner coupler for a precleaning system, comprising:
a first grooved track having a first groove opening extending along a length of the first grooved track; and
a second grooved track parallel to the first grooved track, the second grooved track having a second groove opening extending along a length of the second grooved track;
wherein the first groove opening and the second groove opening face one another; and at least one precleaner guard element extends from the first grooved track to the second grooved track.

2. The precleaner coupler of claim 1, further including a groove including a third groove opening connecting the first groove opening to the second groove opening.

3. The precleaner coupler of claim 2, wherein the groove extends normal to the first grooved track and the second grooved track.

4. The precleaner coupler of claim 2, wherein the groove opens toward the first and second grooved tracks.

5. The precleaner coupler of claim 2, wherein walls of the groove, the first grooved track, and the second grooved track form outer edges of the precleaner coupler, and the precleaner coupler is generally rectangular in shape.

6. The precleaner coupler of claim 2, wherein the first and second grooved tracks are longer than the groove.

7. The precleaner coupler of claim 1, wherein walls of the first grooved track and the second grooved track form outer side edges of the precleaner coupler.

8. The precleaner coupler of claim 1, wherein the first and second grooved tracks each include a front wall and a generally parallel back wall, and the at least one precleaner guard element extends from the front walls.

9. The precleaner coupler of claim 1, wherein the precleaner guard element includes a plurality of guard elements including a plurality of louvers.

10. The precleaner coupler of claim 9, wherein the plurality of louvers have different shapes.

11. The precleaner coupler of claim 10, wherein the plurality of louvers include at least four louvers, and two of the four louvers have the same shapes.

12. The precleaner coupler of claim 1, wherein the first and second grooved tracks each include a locking tab.

13. The precleaner coupler of claim 1, wherein the precleaner guard element includes a plurality of guard elements including a plurality of screening bars.

14. The precleaner coupler of claim 1, wherein the precleaner guard element includes a duct.

15. A precleaner system for precleaning intake air for an air intake system, the precleaner system comprising:
a cyclonic precleaner including:
a precleaner outer wall, having a plurality of precleaner inlets extending through the precleaner outer wall, each precleaner inlet in fluid communication with the intake air;
a housing;
a plenum formed by the housing and the precleaner outer wall from each of the plurality of precleaners, the plenum in fluid communication with the plurality of precleaner inlets;
a system inlet in the shape of a hollow cylinder extending away from the housing and in fluid communication with the plenum; and
a precleaner coupler including:
a first grooved track having a first groove opening extending along a length of the first grooved track; and
a second grooved track having a second groove opening extending along a length of the second grooved track;
wherein the first groove opening and the second groove opening face one another and are sized to clamp the precleaner outer wall to the housing.

16. The precleaner system of claim 15, wherein the precleaner outer wall includes an engagement surface, and wherein a front wall of the first grooved track is in contact with the engagement surface.

17. The precleaner system of claim 15, wherein the housing includes a guide rail, and wherein a back wall of the first grooved track is in contact with the guide rail.

18. The precleaner system of claim 15, wherein the precleaner includes a gasket between the precleaner outer wall and the housing.

19. A method of assembling a cyclonic precleaner, the method including:
placing an outer wall having a plurality of precleaner inlets extending through the precleaner outer wall onto a housing, such that the outer wall and the housing form a plenum;
sliding a precleaner coupler over at least a portion of the outer wall and the housing to clamp the outer wall to the housing, the precleaner coupler including:
a first grooved track having a first groove opening extending along a length of the first grooved track; and
a second grooved track having a second groove opening extending along a length of the second grooved track,
wherein the first groove opening and the second groove opening face one another and are sized to clamp the precleaner outer wall to the housing.

20. The method of assembling a cyclonic precleaner of claim 19, the method further including locking the precleaner coupler onto the outer wall using a locking ramp.
